(19) United States
(12) Patent Application Publication
(10) Pub. No.: US 2012/0220711 A1
(43) Pub. Date: Aug. 30, 2012

(54) HEAT RESISTANT PLA-ABS COMPOSITIONS

(76) Inventors: Shixiong Zhu, Westlake, OH (US); Roger W. Avakian, Solon, OH (US)

(21) Appl. No.: 13/504,269

(22) PCT Filed: Oct. 27, 2010
(86) PCT No.: PCT/US10/54233

§ 371 Date: Apr. 26, 2012

Related U.S. Application Data
(60) Provisional application No. 61/256,743, filed on Oct. 30, 2009.

(51) Int. Cl. C08L 67/04; C08K 3/22

(52) U.S. Cl. 524/521; 525/190

(57) ABSTRACT

A significant disadvantage of the use of polylactic acid (PLA) has been overcome by the use of acrylonitrile-butadiene-styrene (ABS) in combination with an epoxy functional styrene-acrylate oligomeric chain extender. The composition also often exceeds a threshold of 65° C. in heat deflection temperature. Use of an impact modifier further improves the industrial versatility of the heat resistant PLA composition.

### CLAIM OF PRIORITY

This application claims priority from U.S. Provisional Patent Application Ser. No. 61/256,743 bearing Attorney Docket Number 12009014 and filed on Oct. 30, 2009, which is incorporated by reference.

### FIELD OF THE INVENTION

This invention relates to new compositions including polylactic acid and having increased heat resistance to improve structural integrity during use of the composition containing polylactic acid.

### BACKGROUND OF THE INVENTION

Plastic articles have replaced glass, metal, and wood articles because plastic can be engineered to not shatter, rust, or rot. The durability of plastic articles also creates a disposal dilemma. Also, many plastic resins are made from petrochemicals, which have long-term supply and cost issues.

Therefore, there is a considerable effort underway to find biologically-derived and sustainable sources of thermoplastic resins, preferably those which degrade or compost to also resolve the disposal dilemma.

Polylactic acid, also known as polylactide or PLA, has been explored as a thermoplastic resin from biologically sustainable origins which can replace petrochemically originated resins.

### SUMMARY OF THE INVENTION

While polylactic acid is probably one of the three most popular bio-derived resins being explored, it has the distinct disadvantage, as when compared to the fossil-derived resins it is meant to replace, in that it has a poor heat deflection temperature.

Heat deflection temperature (HDT) is a measurement of deflection of a sample under flexural load using the protocol of ASTM D648. The flexural load can be either of two settings. For purposes of this invention, 66 pounds per square inch (psi) or 455 kilo-Pascals (kPa) will be used for comparative measurements of heat deflection.

The problem with polylactic acid is that it has a heat deflection temperature under a 455 kPa flexural load of about 55° C. or 131° F. In other words, inside a automobile on an Arizona summer day, PLA would not be sturdy enough to be used as a thermoplastic resin molded into a passenger compartment component, as the case for an electronic handheld device laying on the seat, or as a piece of packaging containing perishable food in a grocery bag on the floor inside the automobile.

The problem with PLA is that it does not have sufficient heat resistance to allow it to be considered as a practical replacement for fossil-derived thermoplastic resins now used in many common plastic articles.

The present invention solves that problem by reacting PLA with an oligomeric chain extender and acrylonitrile-butadiene-styrene (ABS) to form a new polymer which has increased heat resistance, compared with PLA, so that the new composition can be used ubiquitously.

The art has had a long-felt need for solving this heat resistance problem. Published literature of NatureWorks, LLC, a principal manufacturer of PLA, reports at www.natureworksllc.com that adding as much as 50% by weight of ABS to PLA to create a 50-50 PLA-ABS blend improves HDT by as little as 2° C. over the HDT of pure PLA polymer resin. Adding as much as 80% by weight of ABS to PLA does result in an improvement in HDT by 30° C., but at that mixture, it is actually more of an ABS polymer being modified by PLA.

Moreover, the art has had a long-felt need for solving this heat resistance problem, and it has been commonly characterized in some industries that a PLA composition should preferably have at least a 65° C. HDT at 66 psi to be a practical thermoplastic composition of both biologically sustainable origin and practical commercial use. At long last, the present invention has discovered also suitable combinations of reactants to achieve, and exceed, that goal of 65° C. at 66 psi.

The art needs a means to increase the actual HDT values for PLA, while also retaining the resulting composition as principally significantly a PLA composition.

For purposes of this invention, the PLA should be the “significant component”, meaning that PLA is present in at least about thirty weight percent (30%) of the composition.

For some situations when it is desirable to market plastic articles made from the composition as made principally from bio-renewable materials, the PLA can be present as the “principal component”, meaning that it has the highest or equal to highest weight percent of the composition among all ingredients employed. For example, PLA will be the “principal component” in a two-ingredient composition if it has 50% or more weight percent of the total composition. PLA will also be the “principal component” in a three-or-more-ingredient composition if it has a plurality weight percent in excess of any other ingredient, e.g., 34% PLA in a composition with two other ingredients each having 33 weight percent. PLA is also the “principal component” for this invention if its weight percent is equal to the weight percent of one other ingredient, such as in a 30 (PLA)-30-20-20 (other ingredients) in a four-ingredient composition.

It has been found, unexpectedly, that the combination of an oligomeric chain extender and ABS can increase the HDT of a PLA composition by at least 5° C. more than the HDT for PLA alone. A new polymer reacted from PLA, oligomeric chain extender, and ABS can also preferably have a HDT of more than 65° C.

One aspect of the present invention is a heat resistant polylactic acid composition, comprising (a) polylactic acid, (b) emulsion-polymerized acrylonitrile-butadiene-styrene, and (c) an epoxy-functional styrene-acrylic oligomer, and (d) optionally, impact modifier; wherein the acrylonitrile-butadiene-styrene or the optional impact modifier is a source of surfactant to facilitate reaction of the oligomer with the polylactic acid, the acrylonitrile-butadiene-styrene, or both; wherein the composition has polylactic acid as a significant component; and wherein if the blended composition is essentially dried before shaping into a plastic article, then the blended composition after shaping into the plastic article has a heat deflection temperature increase of at least 5° C. more than the heat deflection temperature of the polylactic acid alone, when both are measured at 66 pounds per square inch using the protocol of ASTM D648.

Features and advantages of the composition of the present invention will be further explained with reference to the embodiments and the examples showing the unexpected results as seen in the Drawing.

### BRIEF DESCRIPTION OF THE DRAWING

FIG. 1 is a table comparing HDT results between comparative examples without oligomeric chain extender and examples with oligomeric chain extender.

FIG. 2 is another a table comparing HDT results between comparative examples without oligomeric chain extender and examples with oligomeric chain extender.

### EMBODIMENTS OF THE INVENTION

PLA

PLA is a well-known biopolymer, having the following monomeric repeating group:

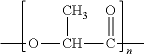

The PLA can be either poly-D-lactide, poly-L-lactide, or a combination of both. PLA is commercially available from NatureWorks, LLC located in all manufacturing regions of the world. Any grade of PLA is a candidate for use in the present invention. The number average molecular weight of PLA can be any which is currently available in a commercial grade or one which is brought to market in the future. To the extent that a current end use of a plastic article could benefit from being made from PLA and from having the heat resistance of the composition of the present invention, then that suitable PLA should be the starting point for constructing the composition of the present invention.

ABS

Acrylonitrile-butadiene-styrene can have the formula of (C₈H₈)ₓ.(C₄H₆)_{y}.(C₃H₃N)_{z}), wherein x is a number to result in the ABS having from 40-60 weight percent of styrene content, wherein y is a number to result in the ABS having from 5-30 weight percent of butadiene content, and wherein z is a number to result in the ABS having from 15-35 weight percent of acrylonitrile content. ABS can be recycled, an important property considering its use with PLA in this invention. The strength of the acrylonitrile and styrene moieties combines with the toughness of the butadiene moieties to result in a very versatile terpolymer suitable for a large number of industrial and consumer uses. ABS can be functional through the temperature range of −40° C. to 130° C.

ABS is commercially available from a large number of well known polymer resin manufacturers, among them: Dow Chemical Co., LG Chemical Company, Sabic Innovative Plastics, and BASF.

These commercially available ABS polymers are not entirely pure resins. As a part of their manufacturing process, particularly the emulsion polymerization process, there are surfactants and other minor ingredients used to facilitate polymerization of the ABS. Because these trace amounts of surfactants remain a part of the polymer resin when sold commercially, their presence can have a positive or negative effect on the mixing of such resins with PLA. Unexpectedly, it has been found that the presence of surfactants in commercially ABS resins can have a very favorable effect on the formation of compositions of the present invention.

Oligomeric Chain Extender

What sets the compositions of this invention apart from merely blended mixtures of PLA and ABS reported previously is the addition of an oligomeric chain extender.

The oligomeric chain extender useful for forming the composition, as defined above, is an epoxy functional low molecular weight styrene-acrylate copolymer such as those disclosed in U.S. Pat. No. 6,605,681 (Villalobos et al.) and U.S. Pat. No. 6,984,694 (Blasius et al.), incorporated by reference herein.

Stated another way, the oligomeric chain extender is the polymerization product of (i) at least one epoxy-functional (meth)acrylic monomer; and (ii) at least one styrenic and/or (meth)acrylic monomer, wherein the polymerization product has an epoxy equivalent weight of from about 180 to about 2800, a number-average epoxy functionality (Efn) value of less than about 30, a weight-average epoxy functionality (Efw) value of up to about 140, and a number-average molecular weight (Mn) value of less than 6000. Preferably, the oligomeric chain extender a polydispersity index of from about 1.5 to about 5.

Of possible candidates of epoxy-functional styrene-acrylate chain extenders, Joncryl® brand chain extender oligomers are preferred, commercially available from BASF (formerly Johnson Polymers) of Milwaukee, Wis. Various grades available and useful are ADR-4300, ADR-4370, and ADR-4368, which are all solids. Alternatively, one can use liquid grades, namely: ADR-4380, ADR-4385, and ADR-4318.

It has been found that the addition of a very small amount of the oligomeric chain extender facilitates a reaction between the PLA and the ABS. A new composition is formed which has the benefits of the bio-derived PLA resin and the heat resistance performance and other desirable physical properties of the ABS.

Optional Stabilizer

To assist in the processing and performance of PLA and ABS, one or more thermal stabilizers can be used, provided that their presence is not otherwise deleterious to performance of the PLA-ABS-oligomer combination.

Optional Impact Modifier

Any conventional impact modifier is a candidate for use in compositions of the present invention. Core/shell impact modifiers, rubbery impact modifiers, polycarbonate, etc. are suitable.

As with the ABS resin, commercially available impact modifiers, as a part of their manufacturing process can also retain surfactants and other minor ingredients used to facilitate reaction to form the impact modifiers. Because these trace amounts of surfactants remain a part of the impact modifier when sold commercially, their presence can have a positive or negative effect on the mixing of such resins with PLA. Unexpectedly, it has been found that the presence of surfactants in commercially available impact modifiers can have a very favorable effect on the formation of compositions of the present invention.

Optional Filler

Any conventional filler is a candidate for use in compositions of the present invention. Fillers increase mass without adversely affecting the physical properties of the composition.

Other Optional Additives

The compositions of the present invention can include other conventional plastics additives in an amount that is sufficient to obtain a desired processing or performance property for the composition. The amount should not be wasteful of the additive nor detrimental to the processing or performance of the composition. Those skilled in the art of thermoplastics compounding, without undue experimentation but with reference to such treatises as Plastics Additives Database (2004) from Plastics Design Library (www.williamandrew.com), can select from many different types of additives for inclusion into the compositions of the present invention.

Non-limiting examples of optional additives include adhesion promoters; biocides (antibacterials, fungicides, and mildewcides), anti-fogging agents; anti-static agents; bonding, blowing and foaming agents; dispersants; fire and flame retardants and smoke suppressants; initiators; lubricants; pigments, colorants and dyes; plasticizers; processing aids; release agents; slip and anti-blocking agents; stabilizers; stearates; ultraviolet light absorbers; viscosity regulators; waxes; and combinations of them.

Table 1 shows acceptable, desirable, and preferable ranges of ingredients useful in the present invention, all expressed in weight percent (wt. %) of the entire composition.

TABLE 1

| | | |
|---|---|---|
| Acceptable | Desirable | Preferable |

Composition

| | | | |
|---|---|---|---|
| PLA | 30-80 | 35-75 | 50-70 |
| ABS | 20-70 | 25-65 | 30-50 |
| Epoxy Functional | 0.25-5 | 0.5-2 | 0.5-1.5 |
| Styrene-Acrylate | | | |
| Oligomeric Chain | | | |
| Extender | | | |

Additives

| | | | |
|---|---|---|---|
| Optional Stabilizer | 0-20 | 5-20 | 5-15 |
| Optional Impact | 0-20 | 5-20 | 5-15 |
| Modifier | | | |
| Optional Filler | 0-50 | 0-40 | 0-30 |

Composition

| | | | |
|---|---|---|---|
| Other Optional | 0-10 | 0-10 | 0-10 |
| Additives | | | |

Processing

The preparation of compositions of the present invention is uncomplicated and can be made in batch or continuous operations.

Mixing in a continuous process typically occurs in an extruder that is elevated to a temperature that is sufficient to melt the polymer matrix with addition either at the head of the extruder or downstream in the extruder of the solid ingredient additives. Extruder speeds can range from about 50 to about 700 revolutions per minute (rpm), and preferably from about 100 to about 300 rpm. Typically, the output from the extruder is pelletized for later shaping by extrusion or molding into polymeric articles.

Mixing in a batch process typically occurs in a Banbury mixer that is also elevated to a temperature that is sufficient to melt the polymer matrix to permit addition of the solid ingredient additives. The mixing speeds range from 60 to 1000 rpm and temperature of mixing can be ambient. Also, the output from the mixer is chopped into smaller sizes for later shaping by extrusion or molding into polymeric articles.

During continuous or batch processing, the oligomeric chain extender reacts with the PLA, the ABS, or both to form the composition of the present invention, assisted by the presence of residual surfactants in the ABS, optional impact modifiers, or both.

Optionally but preferably, prior to batch or continuous melt-mixing, one can dry the ingredients to help reduce the possibility of a moisture-activated degradation or reaction in the melt-mixing vessel. Alternatively, one can use other ways to reduce degradation possibilities, such as incorporating a moisture scavenger or desiccant into the formulation, applying a vacuum within the melt-mixing vessel, etc. Any of these techniques, or combination of techniques, results in the ingredients being dried before or during melt-mixing.

Subsequent extrusion or molding techniques are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (www.williamandrew.com), one can make articles of any conceivable shape and appearance using compositions of the present invention.

Regardless of drying or other techniques during melt-mixing, it has been found that drying the composition before molding can have a direct effect on performance properties, including heat deflection temperature. As the Examples below demonstrate, the amount of drying should be much closer to about 48 hours than about 4 hours, in order to achieve an essentially dry blended composition prior to molding, i.e., having a moisture content of less than 0.1%. To reduce the possibility of drying at a temperature approaching the heat deflection temperature of 65° C., the temperature can be up to about 60° C. without vacuum. Indeed, without undue experimentation, one can identify the best combination of time, temperature, and atmospheric pressure to reduce the time of drying while maximizing the amount of drying, without approaching a temperature which would degrade or otherwise affect performance of the composition shaped as a molded or extruded product.

### USEFULNESS OF THE INVENTION

Any plastic article is a candidate for use of the compositions of the present invention. With the heat durability of PLA now achieved, all types of plastic articles which required at least a 5° C. HDT differential (and preferably a HDT of at least 65° C. at 66 psi), previously made from fossil-derived polymers, can now be made from a sustainable PLA polymer composition.

Plastic articles made from compositions of the present invention can be shaped via molding or extruding for use in the transportation, appliance, electronics, building and construction, biomedical, packaging, and consumer markets.

For example, food packaging can now be made from a PLA composition of the present invention and retain sufficient heat resistance to withstand storage or transport at temperatures approaching 60° C. The plastic article made from a composition of the present invention will retain its structural integrity at least 5° C. higher than with PLA alone and preferably at temperatures below 65° C.

Examples prove the unexpected nature of the present invention.

### EXAMPLES

### Comparative Examples A-W and Examples 1-39

Table 2 shows the list of ingredients. Table 3 shows one set of extrusion conditions. Table 4 shows the other set of extrusion conditions. Table 5 shows the molding conditions. Table 6 shows another set of molding conditions. Tables 7-10 show the recipes and the HDT at 66 psi according to ASTM D648. Table 11 shows the physical properties for some of the Examples.

TABLE 2
Ingredients

| Ingredient | Brand Name | Source |
|---|---|---|
| PLA | Ingeo ™ 4042D Polylactic | Natureworks, LLC |
| | Acid | |
| Terluran ABS | Terluran ® GP 35 ABS | BASF |
| Lustran ABS | Lustran ® 348 ABS | Ineos |
| XR 409H High Heat | XR 409H ABS | LG Chem |
| ABS | | |
| Magnum ABS | Dow Magnum ® ABS | Dow Chemical |
| POLYLAC ABS | POLYLAC ® PA-717C | Chi Mei Corp., |
| | ABS | Taiwan |
| Tioxide TiO₂ | Tioxide ® R-FC6 Titanium | Huntsman |
| | Dioxide | |
| Tiona TiO₂ | Tiona ® 188 Titanium | Millenium, a part |
| | Dioxide | of Lyondell |
| Joncryl 4368 | Joncryl ® 4368 Epoxy- | BASF |
| Oligomer | Functional Styrene- | |
| | Acrylate Oligomer | |
| Joncryl 4300 | Joncryl ® 4300 Epoxy- | BASF |
| Oligomer | Functional Styrene- | |
| | Acrylate Oligomer | |
| Paraloid BPM | Paraloid ® BPM 500 | Dow Chemical, |
| Impact Modifier | Acrylic Rubber, Emulsion | formerly Rohm |
| | Polymerized | and Haas |
| Blendex Impact | Blendex ® 338 SBR | Chemtura |
| Modifier | Rubber, Emulsion | |
| | Polymerized | |
| Paraloid KM Impact | Paraloid ® KM 365 Acrylic | Dow Chemical, |
| Modifier | Rubber, Emulsion | formerly Rohm |
| | Polymerized | and Haas |
| Blendex SAN | Blendex ® 863 SAN, | Chemtura |
| | Emulsion Polymerized | |
| Tyril SAN | Tyril ® 125 SAN, Bulk | Dow Chemical |
| | Polymerized | |
| B225 Thermal | B225 Phosphite-Phenolic | BASF, formerly |
| Stabilizer | Thermal Stabilizer | Ciba |
| Tinuvin UV | Tinuvin ® P UV Stabilizer | BASF, formerly |
| Stabilizer | | Ciba |
| CARSTAB DLTDP | CARSTAB ® Dilauryl | Struktol |
| Secondary Thermal | Thiodipropionate | |
| Stabilizer | | |
| Naugard DLTDP | Naugard ® DLTDP | Chemtura |
| Secondary Thermal | | |
| Stabilizer | | |

TABLE 3
Extruder Conditions
All Comparative Examples and Examples, Except Examples
38 and 39

| Pre-Extruder Drying | PLA resin was dried at 80° C. for 8 |
|---|---|
| | hours prior to extrusion |
| Extruder Type | Prism 16 mm Counter-Rotating Twin |
| | Screw Extruder |
| Order of Addition | All ingredients mixed together and fed |
| | into the extruder hopper. |
| All Zones and Die (° C.) | 220 |
| RPM | 250 |

TABLE 4
Extruder Conditions
Examples 38, 39
(Unless Differentiated, Conditions were Same)

| | |
|---|---|
| Pre-Extruder | PLA resin was dried to 0.15% moisture, and |
| Drying | ABS resin was dried 0.18% moisture prior to |
| | extrusion |
| Extruder Type | Coperion 40 mm Counter-Rotating Twin Screw |
| | Extruder |

| | Ingredient | Tube & Screw | Set Pt % |
|---|---|---|---|
| Hopper Feed | PLA | 60 mm & 40 mm | 52.1 (38), |
| Conditions | | | 42.1 (39) |
| | ABS | 35 mm & 30 mm | 40 (38), |
| | | | 50 (39) |
| | Other | 35 mm & 30 mm | 7.9 |
| | Ingredients | | |

Process Parameters

| Run Rate (kg/hr): | 84 (38), 89 (39) | |
|---|---|---|
| Conditions | Set | Actual |
| Zone 2 Temp (° C.): | 204 | 204 |
| Zone 3 Temp (° C.): | 199 | 199 |
| Zone 4 Temp (° C.): | 199 | 198 |
| Zone 5 Temp (° C.): | 193 | 198 |
| Zone 6 Temp (° C.): | 193 | 198 |
| Zone 7 Temp (° C.): | 193 | 192 |
| Zone 8 Temp (° C.): | 188 | 204 (38), |
| | | 206 (39) |
| Zone 9 Temp (° C.): | 188 | 200 (38), |
| | | 199 (39) |
| Die Temp (° C.): | 193 | 193 |

| | |
|---|---|
| Screw Speed (RPM) | 195 |
| Vacuum (mm of Hg) | 384 |
| Melt Temp (Hand Probe) (° C.): | 239 (38), 238-242 (39) |
| Die Pressure (mPa) | 7.55 |
| Torque (%) | 90-95 |
| Power (kW) | 15.6 (38), 16.4 (39) |
| SME (kW-hr/kg) | 0.186 (38), 0.185 (39) |
| Water Bath | 40% Submerged |
| Pelletizer # | 3 |
| Pelletize Blade Speed (RPM) | 915 |
| Feed Roller Speed (RPM) | 81 |
| Classifier # | Double Deck |

TABLE 5
Molding Conditions
All Comparative Examples and Examples, Except Examples
38 and 39
88 ton Nissei molding machine
Drying Conditions before Molding:

| | |
|---|---|
| Temperature (° C.) | 60 |
| Time (h) | 10-12 |

Temperatures:

| | |
|---|---|
| Nozzle (° C.) | 216 |
| Zone 1 (° C.) | 213 |
| Zone 2 (° C.) | 210 |
| Zone 3 (° C.) | 210 |
| Mold (° C.) | 49-65 |
| Oil Temp (° C.) | 27-29 |

Speeds:

| | |
|---|---|
| Screw RPM (%) | 65 (LV) |
| % Shot - Inj Vel Stg 1 | 50 |
| % Shot - Inj Vel Stg 2 | 40 |
| % Shot - Inj Vel Stg 3 | 30 |
| % Shot - Inj Vel Stg 4 | 20 |
| % Shot - Inj Vel Stg 5 | 10 |

Pressures:

| | |
|---|---|
| Hold Stg 1 (mPa) - | 3.44 |
| Time(sec) | 5 |
| Hold Stg 2 (mPa) - | 2.76 |
| Time(sec) | 5 |

Timers:

| | |
|---|---|
| Injection Hold (sec) | 7 |
| Cooling Time (sec) | 30 |

Operation Settings:

| | |
|---|---|
| Shot Size (mm) | 58 |
| Cushion (mm) | 1.4-1.6 |

TABLE 6
Molding Conditions
Examples 38 and 39
120 ton Demag molding machine

| Drying Conditions: | | |
|---|---|---|
| Temperature (° C.)/Time (hrs) | Did not dry because | |
| | moisture content was low | |
| | enough for molding | |
| Moisture Content (%) | 0.018 | |
| | Setup | Actual |
| Temperatures: | | |
| Nozzle (° C.) | 216 | 217 |
| Zone 2 (° C.) | 210 | 211 |
| Zone 3 (° C.) | 210 | 211 |
| Zone 4 (° C.) | 204 | 204 |
| Mold (° C.) | 54 | 56 |
| Oil Temp (° C.) | 27 | 26 |
| Speeds: | | |

| | |
|---|---|
| Screw RPM | 100 |
| % Shot - Inj Vel (in/sec) | 1 |
| Pressures: | |
| Injection Pressure (mPa) | 7.22 |
| Hold Pressure (mPa) | 6.60 |
| Back Pressure (mPa) | 0.69 |
| Timers: | |
| Injection Hold (sec) | 7 |
| Cure/Cool Time (sec) | 15 |
| Fill Time (sec) | 2.54 |
| Cycle Time (sec) | 31.86 |
| Operation Settings: | |
| Shot Size (cm) | 3.93 |
| Cushion (cm) | 0.53 |
| Cut-Off Position (cm) | 1.27 |
| Decompression (cm) | 0.76 |

TABLE 7
Recipes (Wt. %) and HDT Results

| | | | | | Joncryl | |
|---|---|---|---|---|---|---|
| | | Terluran | Tioxide | B225 | 4368 | HDT |
| Ex. | PLA | ABS | TiO₂ | Stabilizer | Oligomer | (° C.) |
| A | 0 | 100 | 0 | 0 | 0 | 90.9 |
| B | 30 | 69.3 | 0.5 | 0.2 | 0 | 81.6 |
| C | 50 | 49.3 | 0.5 | 0.2 | 0 | 61.5 |
| D | 70 | 29.3 | 0.5 | 0.2 | 0 | 54.8 |
| E | 100 | 0 | 0 | 0 | 0 | 54.0 |
| F | 0 | 98.8 | 0.5 | 0.2 | 0.5 | 91.4 |
| 1 | 30 | 68.8 | 0.5 | 0.2 | 0.5 | 82.3 |
| 2 | 50 | 48.8 | 0.5 | 0.2 | 0.5 | 62.0 |
| 3 | 70 | 28.8 | 0.5 | 0.2 | 0.5 | 55.3 |
| G | 98 | 0 | 0 | 0 | 2.0 | 56.0 |
| 4 | 50 | 48.3 | 0.5 | 0.2 | 1 | 62.0 |
| 5 | 50 | 47.3 | 0.5 | 0.2 | 2 | 62.0 |
| H | 0 | 100 | 0 | 0 | 0 | 90.9 |
| I | 30 | 70 | 0 | 0 | 0 | 81.6 |
| J | 35 | 65 | 0 | 0 | 0 | 74.0 |
| K | 40 | 60 | 0 | 0 | 0 | 73.0 |
| L | 45 | 55 | 0 | 0 | 0 | 71.0 |
| M | 50 | 50 | 0 | 0 | 0 | 61.5 |
| N | 55 | 45 | 0 | 0 | 0 | 60.3 |
| O | 60 | 40 | 0 | 0 | 0 | 59.9 |
| P | 65 | 35 | 0 | 0 | 0 | 58.0 |
| Q | 70 | 30 | 0 | 0 | 0 | 57.0 |
| R | 75 | 25 | 0 | 0 | 0 | 57.0 |
| S | 80 | 20 | 0 | 0 | 0 | 55.0 |
| T | 100 | 0 | 0 | 0 | 0 | 54.0 |
| U | 0 | 98 | 0 | 0 | 2 | 91.4 |
| 6 | 29.7 | 69.3 | 0 | 0 | 1 | 82.3 |
| 7 | 34.7 | 64.3 | 0 | 0 | 1 | 77.5 |
| 8 | 39.6 | 59.4 | 0 | 0 | 1 | 75.6 |
| 9 | 44.6 | 54.4 | 0 | 0 | 1 | 73.2 |
| 10 | 49.5 | 49.5 | 0 | 0 | 1 | 72.0 |
| 11 | 54.5 | 44.5 | 0 | 0 | 1 | 71.8 |
| 12 | 59.4 | 39.6 | 0 | 0 | 1 | 67.9 |
| 13 | 64.4 | 34.6 | 0 | 0 | 1 | 63.0 |
| 14 | 69.3 | 29.7 | 0 | 0 | 1 | 63.0 |
| 15 | 74.3 | 24.7 | 0 | 0 | 1 | 62.0 |
| 16 | 79.2 | 19.8 | 0 | 0 | 1 | 56.0 |
| V | 98 | 0 | 0 | 0 | 2.0 | 56.0 |

TABLE 8
Recipes (Wt. %) and HDT Results

| | | | | | | | Paraloid | Paraloid | |
|---|---|---|---|---|---|---|---|---|---|
| | | | | Joncryl | Joncryl | Blendex | KM | BPM | |
| | | Terluran | Tioxide | 4368 | 4300 | Impact | Impact | Impact | HDT |
| Example | PLA | ABS | TiO₂ | Oligomer | Oligomer | Modifier | Modifier | Modifier | (° C.) |
| 17 | 46 | 46 | 2 | 1 | | | | 5 | 79.0 |
| W | 46.5 | 46.5 | 2 | 0 | | | | 5 | 63.0 |
| 18 | 46 | 46 | 2 | 1 | | | 5 | | 80.9 |
| 19 | 47 | 47 | 0 | 1 | | | | 5 | 78.1 |
| 20 | 46 | 46 | 2 | 1 | | 5 | | | 77.3 |
| 21 | 45.5 | 45.5 | 2 | | 2 | | | 5 | 77.8 |

TABLE 9
Recipes (Wt. % and HDT Results

| | | | | | | XR 409 H | | Joncryl | Paraloid | | | | |
|---|---|---|---|---|---|---|---|---|---|---|---|---|---|
| | | Terl- | Lus- | Mag- | POLY- | High | Tiox- | 4368 | BPM | | Blendex | | |
| | | uran | tran | num | LAC | Heat | ide | Oligo- | Impact | Blendex | Impact | Tyril | HDT |
| Ex. | PLA | ABS | ABS | ABS | ABS | ABS | TiO₂ | mer | Modifier | SAN | Modifier | SAN | (° C.) |
| 22 | 36 | 54 | | | | | 4 | 1 | 5 | 0 | 0 | 0 | 78.0 |
| 23 | 36 | 37.8 | | | | | 4 | 1 | 5 | 10.8 | 5.4 | 0 | 78.9 |
| 24 | 36 | | 54 | | | | 4 | 1 | 5 | 0 | 0 | 0 | 85.5 |
| 25 | 36 | | 37.8 | | | | 4 | 1 | 5 | 10.8 | 5.4 | 0 | 86.0 |
| 26 | 36 | | 32.4 | | | | 4 | 1 | 5 | 16.2 | 5.4 | 0 | 87.0 |
| 27 | 36 | | 32.4 | | | | 4 | 1 | 5 | 0 | 5.4 | 16.2 | 87.2 |
| 28 | 36 | | | | | | 4 | 1 | 5.0 | 40.5 | 13.5 | | 89.0 |
| 29 | 36 | | | | | | 4 | 1 | 5.0 | 0 | 13.5 | 40.5 | 88.0 |
| 30 | 36 | | | 54 | | | 4 | 1 | 5.0 | 0 | 0 | 0 | 87.0 |
| 31 | 36 | | | | 54 | | 4 | 1 | 5.0 | 0 | 0 | 0 | 84.0 |
| 32 | 36 | | | | 32.4 | | 4 | 1 | 5.0 | 16.2 | 5.4 | 0 | 86.0 |
| 33 | 36 | | | | | 54 | 4 | 1 | 5.0 | 0 | 0 | 0 | 107.0 |

TABLE 10
Recipes (Wt. %) and HDT Results

| Example | 34 | 35 | 36 | 37 | 38 | 39 |
|---|---|---|---|---|---|---|
| PLA | 40 | 40 | 50 | 50 | 40 | 50 |
| XR 409 H High Heat | 52.1 | 52.1 | 42.1 | 42.1 | 52.1 | 42.1 |
| ABS | | | | | | |
| Tioxide TiO₂ | 1 | 1 | 1 | 1 | | |
| Tiona TiO₂ | | | | | 1 | 1 |
| Joncryl 4368 Oligomer | 1 | 1 | 1 | 1 | 1 | 1 |
| Paraloid BPM Impact | 5 | | 5 | | | |
| Modifier | | | | | | |
| Blendex Impact | | 5 | | 5 | 5.0 | 5.0 |
| Modifier | | | | | | |
| B225 Thermal | 0.2 | 0.2 | 0.2 | 0.2 | 0.2 | 0.2 |
| Stabilizer | | | | | | |
| Tinuvin UV Stabilizer | 0.5 | 0.5 | 0.5 | 0.5 | 0.5 | 0.5 |
| CARSTAB DLTDP | 0.2 | 0.2 | 0.2 | 0.2 | | |
| Secondary Thermal | | | | | | |
| Stabilizer | | | | | | |
| Naugard DLTDP | | | | | 0.2 | 0.2 |
| Secondary Thermal | | | | | | |
| Stabilizer | | | | | | |
| HDT (° C.) | 102.0 | 100.0 | 91.0 | 89.0 | 98.1 | 89.3 |

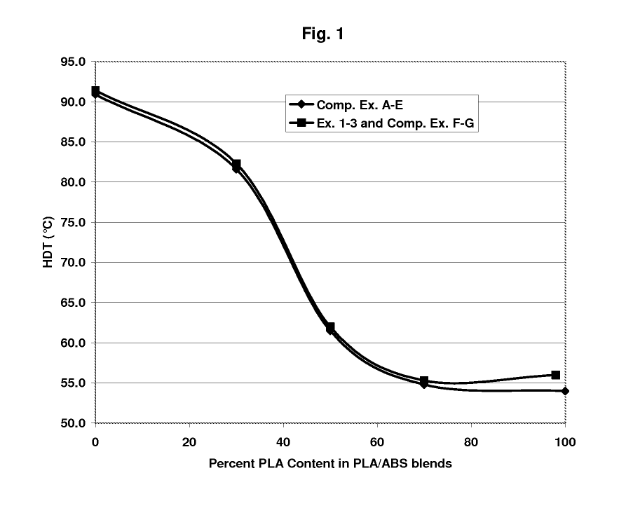

Comparative Example A shows that Terluran® brand ABS has a HDT of 90.9° C., and Comparative Example E shows Ingeo™4042D PLA has a HDT of 54.0° C. While it might be predicted that blends of PLA and ABS would have proportional HDTs reflective of the proportions of the blends, the actual results are quite unpredictable. For example, FIG. 1 shows the comparison of Comparative Examples A-E (stabilizer, but no oligomer) with Comparative Examples F and G (to anchor the end values) and Examples 1-3 (stabilizer and oligomer). The curves are unpredictable relative to the proportionate, predictable norm but surprisingly the same. The presence of B225 thermal stabilizer negates any difference between the presence and absence of oligomer. As such, thermal stabilizer is not needed, surprisingly. Moreover, adding a minority of ABS to a majority of PLA, even with oligomer present results in a less-than-predictable HDT value.

Examples 4 and 5 reveal that doubling the amount of oligomer does not increase the HDT property. Surprisingly, 1 weight percent of oligomer works as well as 2 weight percent.

A comparison of Comparative Example E and Comparative Example G also reveals that the addition of two weight percent of Joncryl oligomer to PLA only increases HDT by 2° C.

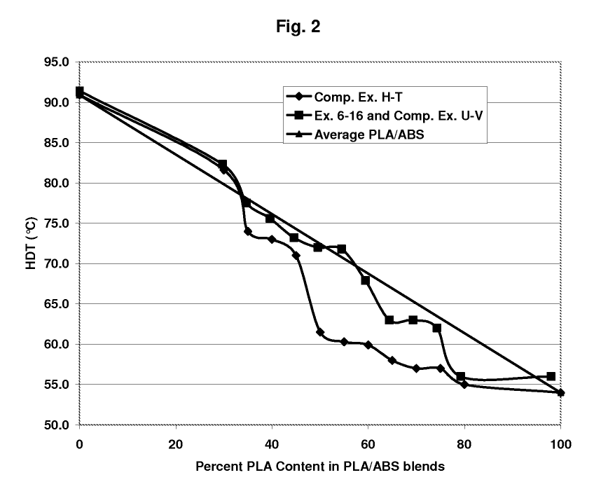

FIG. 2 offers a visual comparison of the performance of Comparative Examples H-T and Comparative Examples U and V (again to anchor the line) and Examples 6-16. None of these Comparative Examples or Examples has any B225 thermal stabilizer present. Both lines are exceedingly erratic in their measurements, but the trend is clear that but for the presence of Joncryl oligomer, a blend of PLA and ABS would be severely underperforming. For example, comparing the HDT of Example 11 with Comparative Example N, with only the addition of 1 weight percent of Joncryl oligomer, Example 11 outperforms Comparative Example by 10.3° C., a total of 16.7% improvement, unexpectedly, given the way Examples 1-5 had performed.

FIG. 2 and Table 7 confirm the finding above that merely adding Joncryl oligomer to PLA does not appreciably change HDT values, as seen in a comparison of Comparative Example T (54.0° C.) and Comparative Example V (56.0° C.).

Moreover, Table 7 also shows that merely adding Joncryl oligomer to ABS also does not appreciably change HDT values, as seen in a comparison of Comparative Example U (91.4° C.) with Comparative Example A (90.9° C.).

For the invention to work, PLA, ABS, and Joncryl oligomer must be present, and as shown in Examples 4 and 5, Joncryl oligomer need not exceed more than about 1 weight percent to be effective.

Without being limited to a particular theory, it is believed that the blend of PLA and ABS and Joncryl oligomer includes a reaction involving the oligomer and at least the ABS if not also the ABS and the PLA. The epoxy functionality on the oligomer makes it reactive, and perhaps residual chemicals present in the parts-per-million range (below the limits of normal analytical detection) contribute to the reaction in some manner. For example, surfactants are known to be used in emulsion-polymerized ABS. Emulsion-polymerized ABS was used in these Examples. It is also believed that ABS polymerizes via addition reaction and also reacts with the oligomer here via an addition reaction mechanism, not via a condensation reaction mechanism.

Table 8 shows a direct comparison of Comparative Example W with Example 17, both having the addition of an impact modifier. Example 17 has a 25% better HDT value. Example 18 with a different impact modifier than Example 17 shows the HDT improvement is not driven by the type of the impact modifier. Example 19 shows the absence of titanium dioxide does not appreciably lower the HDT improvement. Examples 20 and 21 show that an alternative grade of Joncryl oligomer does not significantly diminish the HDT improvement, while also showing again that doubling the amount of oligomer present does not appreciably improve the HDT value.

Table 9 shows a series of variations of embodiments, using a variety of commercially available ABS resins (all emulsion polymerized) with a single grade of PLA, Joncryl oligomer, TiO₂, and impact modifier. Examples 22, 24, 30, 31, and 33 do not employ the Styrene Acrylonitrile (SAN) nor the Blendex SBR resin. Examples 23, 25-29, and 32 do, and it is believed that the extrusion conditions are suitable for a reaction between the Blendex SBR resin and the SAN to form in situ ABS to augment the presence of the emulsion-polymerized ABS in 23, 25-27, and 32. Examples 28 and 29 use the in situ polymerized ABS as the only ABS in the melt mixture pelletized for later molding. It is believed that the Blendex SBR resin and the Blendex SAN resin also have minute traces of residual chemicals which assist in the interaction of the Joncryl oligomer with the ABS formed in situ and the PLA.

The HDT values of Examples 22-33 range between −13%-+18% of 100% ABS (Comparative Example A). But more significantly, the the improvement in HDT values of Examples 22-33 range between 44%-98% of 100% PLA.

The XR 409H High Heat ABS of Example 33 significantly outperformed other ABS candidates of Examples 22, 24, 30, and 31, making it the preferred ABS to be used.

Examples 34-39 in Table 10 therefore focused on PLA, XR 409H High Heat ABS, and Joncryl 4368 oligomer, with some variation in TiO₂ used, the type of impact modifier used, the return of B225 thermal stabilizer (needed for commercial embodiments), the addition of ultraviolet stabilizer (also needed for commercial embodiments), and the addition of alternate secondary thermal stabilizers. Examples 38 and 39 differed from Examples 34-37 in that the compounds were made on a production scale extruder and molded on a production scale injection molding machine.

With PLA as the majority ingredient (Examples 36, 37, and 39), the average HDT was 89.76° C., only 1% less than the HDT for ABS as found in Comparative Example A using the Terluran® ABS. With the ABS as the majority ingredient (Examples 34, 35, and 38), the average HDT was 100.03° C., more than 10% better than the HDT for ABS as found in Comparative Example A using the Terluran® ABS. Also the average HDT of 100.03° C. is 78% better than the HDT of the 50-50 blend of PLA-ABS reported by NatureWorks, LLC in their product literature entitled “Technology Focus Report: Blends of PLA with Other Thermoplastics” mentioned previously. Stated another way, the composition of the present invention has about a 12% HDT improvement for a 42-52-1 PLA-ABS-Oligomer composition over the 20-80 PLA-ABS blend reported by NatureWorks with 28% less ABS present (100.03° C. vs. 89° C.).

Among the PLA-majority ingredient Examples 36, 37, and 39, the maximum variation in HDT was 2° C. and 2%. Among the PLA-minority ingredient Examples 34, 35, and 38, the maximum variation in HDT was 3.9° C. and 3.9%. These comparisons show that the effect of different TiO₂, the effect of different impact modifier, and the effect of secondary thermal stabilizer were minimal. Moreover, the return of B225 thermal stabilizer was manageable and not detractive from the performance of the embodiments of the invention. Finally, the invention as embodied and made on laboratory scale equipment successfully transitioned to production scale equipment without loss of HDT properties.

Table 11 shows the other physical properties measured for the embodiments of Examples 38 and 39. All physical properties were acceptable for use as a commercial product.

TABLE 11

| Test | Method | N | Example 38 | Example 39 |
|---|---|---|---|---|
| Specific Gravity by | ASTM | 1 | 1.135 | 1.148 |
| liquid displacement | D792 | | | |
| Flex Modulus, ⅛″, | ASTM | 6 | 411,945 ± 2563 | 398,025 ± 13001 |
| 0.05″/min (psi) | D790 | | | |
| Flex Strength, ⅛″, | ASTM | 6 | 12,100 ± 443 | 12,180 ± 195 |
| 0.05″/min (psi) | D790 | | | |
| Impact Izod, | ASTM | 8 | 1.92 ± 0.06 | 1.72 ± 0.21 |
| Notched, | | | | |
| ⅛, (ft-lbs/in) | D256 | | | |
| Pellet Size per gram | Internal | 1 | 52 | 66 |
| (Pellet/1 gram) | | | | |
| Visual Inspection | Internal | 1 | Pass | Pass |
| for Contamination | | | | |
| Moisture, Weight | Internal | 1 | 0.018 | 0.019 |
| loss, Vapor-Pro (%) | | | | |

N = number of test bars tested.

### Proof Examples AA-HH

Table 12 provides further demonstration of reaction, as measured using torque rheometry, via extrusions using the same equipment as used in Examples 1-37. Proof Examples AA-HH compare 100% of various polymers with a 98%/2% ratio of those polymers, respectively, with Joncryl Epoxy-Functional Styrene-Acrylate Oligomer. Tyril SAN is bulk polymerized; all others are emulsion-polymerized. The increase in torque and increase in die pressure, all other factors being equal, showed a reaction occurring. These Proof Examples provide confirmation that residual chemicals in emulsion-polymerized polymers contribute to the reaction of Joncryl oligomer with those polymers whether ABS or an optional impact modifier.

TABLE 12
Proof of Reaction

| | | Feeder | | Die | |
|---|---|---|---|---|---|
| Ex. | Formulations | Rate | Torque | Pressure | Reaction |
| AA | 100% Paraloid BPM | 12% | 75~80 | 22 | No |
| | Impact Modifier | | | | |
| BB | 98%/2% Paraloid | 12% | 88~90 | 29 | Yes |
| | BPM Impact | | | | |
| | Modifier/Joncryl | | | | |
| | 4368 Oligomer | | | | |
| CC | 100% Paraloid | 15% | 70~74 | 26 | No |
| | KM334 Impact | | | | |
| | Modifier (Dow | | | | |
| | Chemical) | | | | |
| DD | 98%/2% Paraloid | 15% | 93~96 | 38 | Yes |
| | KM334/Joncryl 4368 | | | | |
| | Oligomer | | | | |
| EE | 100% Blendex SAN | 12% | 75~80 | 15 | No |
| FF | 98%/2% Blendex | 10% | 85~90 | 16 | Yes |
| | SAN 863/Joncryl | | | | |
| | 4368 Oligomer | | | | |
| GG | 100% Tyril SAN | 10% | 75~80 | 10 | No |
| HH | 98%/2% SAN Tyril | 10% | 75~82 | 10 | No |
| | 125/Joncryl 4368 | | | | |
| | Oligomer | | | | |

The invention is not limited to the above embodiments. The claims follow.

What is claimed is:

1. A heat resistant polylactic acid composition, comprising:
(a) polylactic acid,
(b) acrylonitrile-butadiene-styrene,
(c) an epoxy-functional styrene-acrylic oligomer, and
(d) optionally, impact modifier;
wherein the acrylonitrile-butadiene-styrene or the optional impact modifier is a source of surfactant to facilitate reaction of the oligomer with the polylactic acid, the acrylonitrile-butadiene-styrene, or both;
wherein the composition has polylactic acid as a significant component; and
wherein if the blended composition is essentially dried before shaping into a plastic article, then the blended composition after shaping into the plastic article has a heat deflection temperature increase of at least 5° C. more than the heat deflection temperature of the polylactic acid alone, when both are measured at 66 pounds per square inch using the protocol of ASTM D648.

2. The composition of claim 1, wherein if the blended composition is essentially dried before shaping into a plastic article, then the blended composition after shaping into the plastic article has a heat deflection temperature of at least 65° C. at 66 pounds per square inch using the protocol of ASTM D648.

3. The composition of claim 1, wherein the acrylonitrile-butadiene-styrene has residual surfactant present therein.

4. The composition of claim 1, wherein the polylactic acid and the acrylonitrile-butadiene-styrene are dried before or during being combined.

5. The composition of claim 1, wherein the impact modifier is present and has residual surfactant therein.

6. The composition of claim 1, further comprising titanium dioxide.

7. The composition of claim 1, wherein the polylactic acid comprises poly-D-lactide, poly-L-lactide, or a combination of both, and wherein the amount of epoxy-functional styrene-acrylic oligomer is present in the composition at less than about 2 weight percent.

8. The composition of claim 3, wherein the amount of ABS ranges from about 20 to about 70 weight percent of the total composition, and wherein the amount of epoxy-functional styrene-acrylic oligomer is present in the composition at less than about 2 weight percent.

9. The composition of claim 1, the acrylonitrile-butadiene-styrene has from 40-60 weight percent of styrene content, from 5-30 weight percent of butadiene content, and from 15-35 weight percent of acrylonitrile content.

10. The composition of claim 3, wherein the acrylonitrile-butadiene-styrene has from 40-60 weight percent of styrene content, from 5-30 weight percent of butadiene content, and from 15-35 weight percent of acrylonitrile content.

11. A plastic article shaped from a blended composition of claim 1.

12. The article of claim 11, wherein the article is molded or extruded and wherein the article is shaped for use in transportation, appliance, electronics, building and construction, packaging, or consumer markets.

13. A plastic article shaped from a blended composition claim 3, wherein the plastic article has a heat deflection temperature increase of at least 5° C. more than the heat deflection temperature of a plastic article made of polylactic acid alone, when both are measured at 66 pounds per square inch using the protocol of ASTM D648.

14. The article of claim 13, wherein the article is molded or extruded and wherein the article is shaped for use in transportation, appliance, electronics, building and construction, packaging, or consumer markets.

15. A method of making the composition of claim 1, comprising the steps of
(a) gathering ingredients including polylactic acid and acrylonitrile-butadiene-styrene having residual surfactants therein and an epoxy functional styrene-acrylate oligomeric chain extender, and
(b) reacting them into a composition for subsequent molding or extruding into a plastic article shaped for use in transportation, appliance, electronics, building and construction, packaging, or consumer markets.

16. The method of making the composition of claim 15, further comprising the steps of
(c) drying the blended composition to a moisture content of less than 0.1% and
(d) shaping the blended composition into a plastic article for use in transportation, appliance, electronics, building and construction, packaging, or consumer markets.
